(19) United States
(12) Patent Application Publication
(10) Pub. No.: US 2021/0280206 A1
(43) Pub. Date: Sep. 9, 2021

(54) METHOD AND APPARATUS FOR IMPROVING EFFICIENCY OF AUTOMATIC SPEECH RECOGNITION

(71) Applicant: Uniphore Software Systems, Inc., Palo Alto, CA (US)

(72) Inventor: Maragathamani BOOTHALINGAM, Chennai (IN)

(21) Appl. No.: 16/836,861

(22) Filed: Mar. 31, 2020

(30) Foreign Application Priority Data
Mar. 3, 2020 (IN) 202011009110

(51) Int. Cl. G10L 21/0272; G10L 21/02; G10L 15/26; G10L 15/30

(52) U.S. Cl. CPC G10L 21/0272; G10L 15/30; G10L 15/26; G10L 21/0202

(57) ABSTRACT

A method and an apparatus for improving efficiency of automatic speech recognition (ASR) is provided. The apparatus includes a call analytics server comprising a processor and a memory, which perform the method. The method comprises removing non-speech portions from a call audio to produce a pre-processed audio, sending the pre-processed audio from the CAS to an ASR engine, and receiving a call text from the ASR engine. The call text is the speech-to-text conversion of the pre-processed audio, and the call text comprises text corresponding to the speech in the pre-processed audio.

### CROSS-REFERENCE TO RELATED APPLICATIONS

This application claims priority to the Indian Patent Application No. 202011009110, filed on Mar. 3, 2020, which is incorporated by reference in its entirety.

### FIELD

The present invention relates generally to improving call center computing and management systems, and particularly to improving efficiency of automatic speech recognition.

### BACKGROUND

Several businesses need to provide support to its customers, which is provided by a customer care call center. Customers place a call to the call center, where customer service agents address and resolve customer issues. Computerized call management systems are customarily used to assist in logging the calls, and implementing resolution of customer issues. An agent, who is a user of a computerized call management system, is required to capture the issues accurately and plan a resolution to the satisfaction of the customer. One of the tools to assist the agent is automatic speech recognition (ASR), for example, as performed by one or more ASR engines as well known in the art. However, the costs as well as the processing time associated with the use of such ASR engines remains high. Conventional attempts to process (transcribe) audios at a faster pace using ASR engines have yielded a high amount of errors in the accuracy of transcription.

Accordingly, there exists a need to improve the cost and time efficiency of the existing performance of transcribing calls.

### SUMMARY

The present invention provides a method and an apparatus for improving efficiency of automatic speech recognition, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram depicting an apparatus for improving efficiency of automatic speech recognition, in accordance with an embodiment of the present invention.

FIG. 2 is a flow diagram of a method for improving efficiency of automatic speech recognition, for example, as performed by the apparatus of FIG. 1, in accordance with an embodiment of the present invention.

FIG. 3 is a schematic diagram depicting the processing of a call audio, for example, as performed by the method of FIG. 2, in accordance with an embodiment of the present invention.

### DETAILED DESCRIPTION

Embodiments of the present invention relate to a method and an apparatus for improving efficiency of automatic speech recognition. Audio of a call is processed prior to being transcribed by an Automatic Speech Recognition Engine (ASR) to remove portions that do not contain speech. After the audio with removed non-speech portions is transcribed by the ASR engine to text, timestamps in the text are offset according to the durations of removed non-speech portions from the audio. Pre-processing the audio to remove such non-speech portions reduces the total length of the audio, which reduces the length of the audio required to be processed by the ASR engine. Further, removal of non-speech portions (e.g. music, noise) also reduces the processing load on the ASR engine, potentially adding to the efficiency of the reduced length of the audio to be transcribed by the ASR engine. Readjusting the timestamps in the transcribed text to account for the removed non-speech portions from the audio yield a diarized text of the audio in less time and with lower costs than conventional techniques.

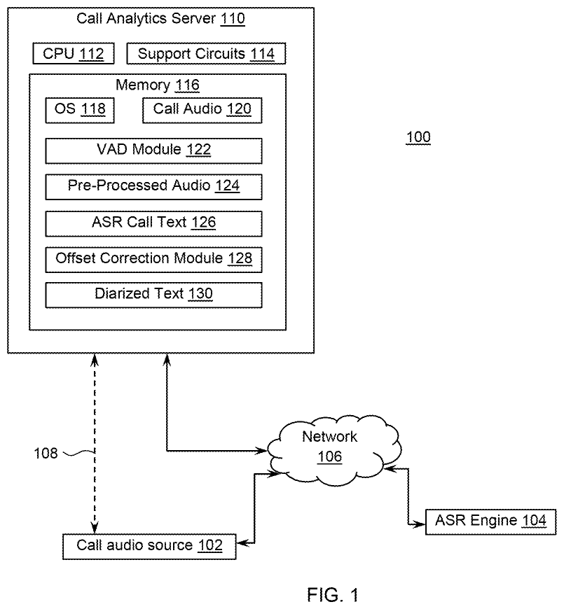

FIG. 1 is a schematic diagram an apparatus 100 for improving efficiency of automatic speech recognition, in accordance with an embodiment of the present invention. The apparatus 100 is deployed, for example, in a call center. The apparatus 100 comprises a call audio source 102, an ASR engine 104, and a call analytics server (CAS) 110, each communicably coupled via a network 106. In some embodiments, the call audio source 102 is communicably coupled to the CAS 110 directly via a link 108, separate from the network 106, and may or may not be communicably coupled to the network 106.

The call audio source 102 provides audio of a call to the CAS 110. In some embodiments, the call audio source 102 is a call center providing live audio of an ongoing call. In some embodiments, the call audio source 102 stores multiple call audios, for example, received from a call center.

The ASR engine 104 is any of the several commercially available or otherwise well-known ASR engines, providing ASR as a service from a cloud-based server, or an ASR engine which can be developed using known techniques. The ASR engines are capable of transcribing speech data to corresponding text data using automatic speech recognition (ASR) techniques as generally known in the art.

The network 106 is a communication network, such as any of the several communication networks known in the art, and for example a packet data switching network such as the Internet, a proprietary network, a wireless GSM network, among others. The network 106 communicates data to and from the call audio source 102 (if connected), the ASR engine 104 and the CAS 110.

The CAS server 110 includes a CPU 112 communicatively coupled to support circuits 114 and a memory 124. The CPU 112 may be any commercially available processor, microprocessor, microcontroller, and the like. The support circuits 114 comprise well-known circuits that provide functionality to the CPU 112, such as, a user interface, clock circuits, network communications, cache, power supplies, I/O circuits, and the like. The memory 116 is any form of digital storage used for storing data and executable software. Such memory includes, but is not limited to, random access memory, read only memory, disk storage, optical storage, and the like.

The memory 116 includes computer readable instructions corresponding to an operating system (OS) 118, a call audio 120 (for example, received from the call audio source 102), a voice activity detection (VAD) module 122, a pre-processed audio 124, an ASR call text 126, an offset correction (OC) module 128, and diarized text 130.

According to some embodiments, the VAD module 122 generates the pre-processed audio 124 by removing non-speech portions from the call audio 120. The non-speech portions include, without limitation, beeps, rings, silence, noise, music, among others. Upon removal of the non-speech portion, the VAD module 122 sends the pre-processed call audio 124 to an ASR engine, for example, the ASR engine 104 over the network 106.

The ASR engine 104 processes the pre-processed audio 124, from which the non-speech portions have been removed. The transcription of the pre-processed audio by the ASR engine 104 is more efficient than the conventional solutions because only speech portions of the audio need to be processed, and because the total time of the audio and therefore the audio processing, is reduced. The ASR engine 104 transcribes the pre-processed audio 124 and generates the ASR call text 126 corresponding to the speech in the pre-processed audio 124, and sends the ASR call text 126 to the CAS 110, for example, over the network 106.

The ASR call text 126 from the ASR engine 104 is received at the CAS 110, for example, by the OC module 128. The OC module 128 introduces offsets in timestamps of the ASR call text 126 corresponding to the duration of the removed non-speech portions from the call audio 120. The OC module 128 offsets the timestamps in the call text 126 for all removed non-speech speech portions, to generate the diarized text 130. In this manner, the diarized text 130 includes timestamps according to the speech in the original call audio 120, without having to process the entire call audio 120 in the ASR engine 104.

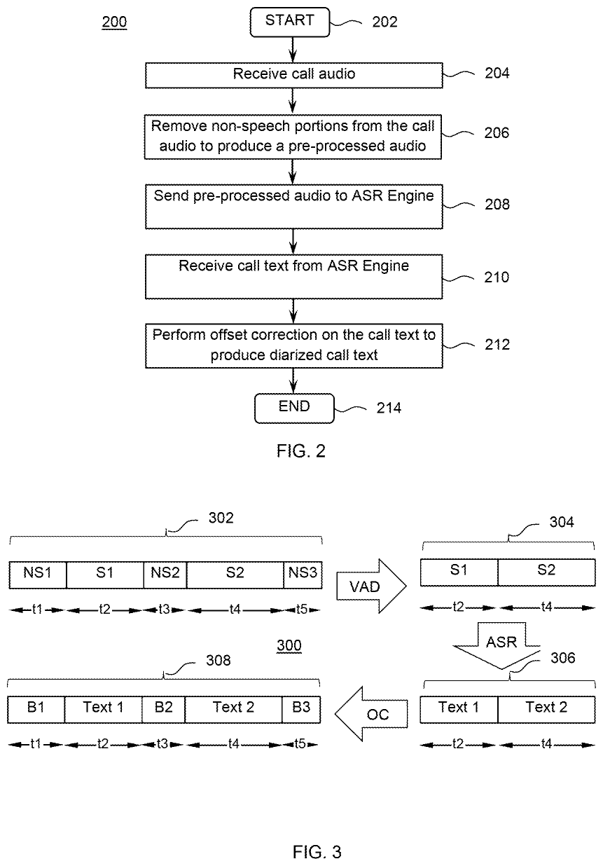

FIG. 2 is a flow diagram of a method 200 for improving efficiency of automatic speech recognition, for example, as performed by the apparatus 100 of FIG. 1, in accordance with an embodiment of the present invention. According to some embodiments, the method 200 is performed by the various modules executed on the CAS 110. The method 200 starts as step 202, and proceeds to step 204, at which the method 200 receives a call audio, for example, the call audio 120. For example, the call audio 120 is of a duration of 3 minutes and has a hold music of 30 seconds and non-speech parts of 20 seconds. The call audio 120 may be a pre-recorded audio received from an external device such as the call audio source 102, for example, a call center or a call audio storage, or recorded on the CAS 110 from a live call in a call center.

The method 200 proceeds to step 206, at which the method 200 removes portions of the call audio 120 that do not include speech, and include, without limitation, beeps, rings, silence, noise, music, among others. Upon removing such non-speech portions from the call audio 120, the method 200 generates or produces the pre-processed audio 124. Continuing the example, from the call audio 120 of 3 minutes, the hold music and non-speech parts (duration of 50 seconds) are removed from the call audio 120, yielding a pre-processed audio 124 of duration 2 minutes and 10 seconds. The method 200 proceeds to step 208, at which the method 200 sends the pre-processed audio 124 to an ASR engine, for example, the ASR engine 104, for performing ASR and/or transcription on the pre-processed audio 124, to generate corresponding text. The ASR engine 104 generates text from the speech in the pre-processed audio 124 and provides transcripts of such speech portions, which have been offset due to removal of the music and non-speech parts. According to some embodiments, steps 204-208 are performed by the VAD module 122.

At step 210, the method 200 receives ASR call text, for example, the ASR call text 126 transcribed by the ASR engine 104 from the pre-processed audio 124. At step 212, the method 200 performs offset correction on the ASR call text 126 to generate the diarized text 130. For example, the method 200 offsets timestamp(s) of a text in the ASR call text 126 by time duration corresponding to the non-speech portion occurring prior to the speech corresponding to the text. According to some embodiments, steps 210 and 212 are performed by the OC module 128. The method 200 proceeds to step 214, at which the method 200 ends.

FIG. 3 is a schematic diagram of a processing flow 300 depicting the processing of a call audio, for example, as performed by the method 200 of FIG. 2, in accordance with an embodiment of the present invention. A call audio 302, similar to the call audio 120 comprises several non-speech and speech portions, indicated by letters NS and S, respectively, indexed in chronological sequence by numerals 1, 2, 3, . . . , and have a time duration denoted by t1, t2, t5. Therefore, the call audio 302 is composed of a non-speech portion NS1 having a time duration t1, followed by a portion S1 comprising speech and having a time duration t2, followed by a non-speech portion NS2 having a time duration t3, followed by a portion S2 comprising speech and having a time duration t4, and concluded by a non-speech portion NS3 having a time duration t5. The call audio 302 has a time duration of t1+t2+t3+t4+5.

Next, the VAD module 122 removes the non-speech portions NS1, NS2 and NS3 from the call audio 302, generating a pre-processed audio 304 composed of only the speech portions S1 and S2, and having a time duration of t2+t4. The VAD module 122 has four sub-modules, Beep & Ring Elimination module, Silence Elimination module, Standalone Noise Elimination module and Music Elimination module. Beep & Ring Elimination module analyzes discrete portions (e.g., each 450 ms) of the call audio for a specific frequency range, because beeps and rings have a defined frequency range according to the geography. Silence Elimination module analyzes discrete portions (e.g., each 10 ms) of the audio and calculates Zero-Crossing rate and Short-Term Energy to detect silence. Standalone Noise Elimination module detects standalone noise based on the Spectral Flatness Measure value calculated over a discrete portion (e.g., a window of size 176 ms). Music Elimination module detects music based on “Null Zero Crossing” rate on discrete portions (e.g., 500 ms) of audio chunks. Further, the VAD module 122 also captures output offset due to removal of non-speech portions. For example, the VAD module 122 may generate a chronological data set of speech and non-speech portions indexed using the milliseconds pointer [(0, 650, Non-Speech), (650, 2300, Speech), (2300, 4000, Non-Speech), (4000, 8450, Speech), . . . ].

Next, the ASR engine 104 converts the speech of the pre-processed audio 304 to a transcribed ASR call text 306 composed of Text 1 including timestamps according to the time duration t2, and Text 2 including timestamps according to the time duration t4. Timestamps on the text of the ASR call text 126 does not correspond to the time of the speech in the original call (call audio 302), because the non-speech portions were removed prior to transcribing the pre-processed audio 304.

Accordingly, next, the OC module 128 corrects the timestamps by accounting for the time durations of the removed non-speech portions, regenerating a diarized text 308 of the call audio 302. For example, the OC module 128 adds the time duration t1 to the times t2 and t4 corresponding to Text 1 and Text 2, respectively, thereby offsetting the timestamps of the entire ASR call text 306 by t1. Next, the OC module 128 adds the time duration t3 to the time t4 corresponding to Text 2 only, thereby offsetting the timestamps of the Text 2 portion of the ASR call text 306 by t3. Finally, the OC module 128 adds a blank time duration t5 after the timestamp at the end of the Text 2, thereby correcting the offset in time introduced due to removal of non-speech portions. The non-speech portions corresponding to the times t1, t3 and t5 are depicted as blanks, B1, B2, B3 respectively, in the diarized text 308. The chronological data set of speech and non-speech portions captured by the VAD module 122, which comprises start and end times of NS1, S1, . . . , is sent from the VAD module 122 to the OC module 128, and used by the OC module 128 to process timestamps. Using the chronological data set, the OC module 128 corrects the offset and determines correct timestamps. In this manner, the call audio 302 is pre-processed (reduced in size by removing non-speech portions) before being transcribed by an ASR engine, which allows a more time and cost-efficient processing by the ASR engine. The timestamps in the transcribed text which are offset due to the removal of non-speech portions, are corrected by adding times corresponding to such non-speech portions at the corresponding positions, thereby regenerating the correct timeline (and timestamps) of the diarized text 308 according to the call audio 302.

The described embodiments enable processing of the call audio by the ASR engine in less than the duration call audio, as compared to conventional solutions, which took at least the time of the call audio for processing. Further, due to increased speech content in the audio, the efficiency of the processing by the ASR engine is enhanced. Therefore, the techniques described herein enable a reduction in time and cost associated with ASR processing, without affecting the accuracy. Further, the techniques described herein can work with both stereo and mono recorded calls.

In case of stereo call audio, the call audio for each speaker is readily separable, and corresponding text can be easily generated. In case of mono call audio, various techniques may be utilized to split the audio according to speakers, in addition to removing the non-speech portions from the call audio.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Finally, structures and functionality presented as discrete components in the example configurations may be implemented as a combined structure or component. These and other variations, modifications, additions, and improvements may fall within the scope of embodiments as described.

While the foregoing is directed to embodiments of the present invention, other and further embodiments of the invention may be devised without departing from the basic scope thereof.

I/we claim:

1. A method for improving efficiency of automatic speech recognition (ASR), the method comprising:
removing, at a call analytics server (CAS), non-speech portions from a call audio to produce a pre-processed audio;
sending the pre-processed audio from the CAS to an ASR engine; and
receiving, at the CAS, a call text from the ASR engine, wherein the call text is the speech-to-text conversion of the pre-processed audio, and the call text comprises text corresponding to the speech in the pre-processed audio.

2. The method of claim 1, further comprising receiving, at the CAS, the call audio from a call audio source.

3. The method of claim 1, wherein the removing comprises removing portions comprising at least one of beeps, rings, silence, noise, or music.

4. The method of claim 1, further comprising performing offset correction on the call text.

5. The method of claim 4, wherein the performing offset correction comprises:
adding, at the CAS, to a timestamp of a text in the call text, time corresponding to a duration of the non-speech portion occurring prior to the speech corresponding to the text.

6. An apparatus for improving efficiency of automatic speech recognition (ASR), the apparatus comprising:
a processor; and
a memory communicably coupled to the processor, wherein the memory comprises computer-executable instructions, which when executed using the processor, perform a method comprising:
removing, at a call analytics server (CAS), non-speech portions from a call audio to produce a pre-processed audio,
sending the pre-processed audio from the CAS to an ASR engine, and
receiving, at the CAS, a call text from the ASR engine, wherein the call text is the speech-to-text conversion of the pre-processed audio, and the call text comprises text corresponding to the speech in the pre-processed audio.

7. The apparatus of claim 6, wherein the method further comprises receiving, at the CAS, the call audio from a call audio source.

8. The apparatus of claim 6, wherein the removing comprises removing portions comprising at least one of beeps, rings, silence, noise, or music.

9. The apparatus of claim 6, further comprising performing offset correction on the call text.

10. The method of claim 9, wherein the performing offset correction comprises:
adding, at the CAS, to a timestamp of a text in the call text, time corresponding to a duration of the non-speech portion occurring prior to the speech corresponding to the text.
